(19) United States
(12) Patent Application Publication
(10) Pub. No.: US 2002/0178041 A1
(43) Pub. Date: Nov. 28, 2002

(54) Method and system for online party planning

(76) Inventors: Paul Krantz, Urbandale, IA (US); Emily M. Sachar, Brooklyn, NY (US); Niky L. Cross, Waukee, IA (US); Todd Breiholz, Clive, IA (US)

Correspondence Address: MCKEE, VOORHEES & SEASE, P.L.C., 801 GRAND AVENUE, SUITE 3200, DES MOINES, IA, 50309-2721, US

(21) Appl. No.: 09/862,362

(22) Filed: May 22, 2001

(51) Int. Cl. G06F 17/60

(52) U.S. Cl. 705/8

(57) ABSTRACT

A system and method of a party planning web site is disclosed. The method provides for providing recurring traffic to a web site through hosting party planning, including promoting a web site as a party planning web site, providing content on the web site related to party planning, prompting a visitor to the web site for party information, facilitating a user's ability to selectively associate party related content links with the party information, and saving the party information including the party associated links to content.

### BACKGROUND OF THE INVENTION

The present invention relates to online party planning services. In particular, the present invention relates to facilitating online party planning in a manner that increases the number of visitors to a web site and/or increases the number of visits per user by enticing visitors with desirable content.

The Internet, and in particular the World Wide Web, has enjoyed explosive growth in recent years. During this time, it has become widely known that there are business advantages associated with maintaining a web site and generating traffic to the web site. By maintaining a web site and generating traffic to the web site, a business receives additional exposure to the consuming public. The business can provide information associated with its products or services. In addition, the business can provide useful information or services online that increase the goodwill that the consuming public attaches to the business, its products, and its services. The business can leverage the traffic associated with its web site into advertising income. By placing links, advertising banners, and other advertising resources on a web site, the business can generate additional income or otherwise promote related or non-related products and services.

There are a number of problems related to attracting visitors to a web site or otherwise increasing traffic to a web site. For example, a consumer may not always have the desire to actively seek out the information that a web site might supply about its products and services. In addition, a consumer may not be interested in visiting a web site that contains advertising information. A web site overburdened with advertising may be slow to load or may be otherwise undesirable to a consumer. Therefore, many successful web sites have focused on providing meaningful services to the consumer for free. This provides consumers with an incentive to visit the web site to use the free services. One such example of a free service is a search engine. Other examples include portals or directories, e-mail services, telephone directory services, mapping services, and other types of services that may be of interest to consumers. In addition, where the services are meaningful and useful to consumers, the web site may generate repeat visitors.

An additional approach to attracting visitors to a web site has been to leverage existing visitor traffic in order to generate new visitor traffic. In other words, the approach has been to generate referrals to a web site from visitors who use the web site. One way this has been accomplished is through allowing a visitor to a web site to send an e-mail or message to another person where the e-mail references the web site and invites the recipient to visit the web site in order to receive or respond to the message. This may be performed in the context of providing services. For example, www.BlueMountain.com provides the free service of sending electronic greeting cards. A visitor to the site may select a card and “send” the card to another person via e-mail along with a personalized greeting. The recipient of a card receives a link to the web site and must then visit the web site in order to view the card. In this manner, visitors to the web site generate additional visitors to the web site.

Another example is sending invitations from a web site. One example of this type of web site is www.evite.com. Instead of sending traditional cards by regular postal mail, electronic invitations to an event are sent. This allows a web site to generate additional traffic from visitors who use the service associated with the site.

Online invitation services, such as evites.com, generally allow a user to send invitations electronically and manage a guest list. Although such web sites have many desirable features, they also suffer from several limitations. Planning a party or event obviously requires much more than simply creating a guest list, sending invitations, and managing RSVP's. And yet, these prior art web site services have been unable to effectively merge ideas and content for planning a party or event with the electronic invitation services.

Another problem is the generation of sales of products and services from the web site. Although advertisements featuring products and services may be associated with holidays and occasions for which invitations and greeting cards are sent, and advertisements may be associated with parties generally, these advertising associations are not as targeted as desired. When advertising is not appropriately targeted, the public is more likely to perceive the advertising as invasive or as a nuisance.

Therefore, there is a real need in the art for an improvement related to the generation of web traffic for an online service. It is therefore a principal object of the present invention to provide a method, apparatus, and system that improves over or solves the problems and deficiencies in the art.

Another object of the present invention is to provide a method, apparatus, and system that is capable of attracting visitors to a web site.

Another object of the present invention is to provide a method, apparatus, and system that is capable of providing a meaningful service to visitors of a web site.

Another object of the present invention is to provide a method, apparatus, and system that is capable of generating repeat visitors to a web site.

Another object of the present invention is to provide a method, apparatus, and system that is capable of generating traffic to a web site by having visitors to the web site refer others to the web site.

Another object of the present invention is to provide a method, apparatus, and system that relates the meaningful service provided by the web site to generating referrals from other visitors.

Another object of the present invention is to provide a method, apparatus, and system that allows a visitor to a web site to plan a party.

Another object of the present invention is to provide a method, apparatus, and system that is capable of attracting and maintaining visitors by providing useful content related to party planning.

Yet another object of the present invention is to provide a method, apparatus, and system that allows a visitor to the web site to associate products or services with a party.

Yet another object of the present invention is to allow visitors to purchase online products or services that they have associated with a party.

Another object of the present invention is to provide a method, apparatus, and system that allows a visitor to a web site who plans a party to associate culinary recipes with a party.

Yet another object of the present invention is to provide a method, apparatus, and system that allows a user planning a party to associate decorating ideas with the party.

Yet another object of the present invention is to provide a method, apparatus, and system for a party planning web site that allows a visitor planning a party to create and maintain a guest list.

Yet another object of the present invention is to provide a method, apparatus, and system for a web site that permits a visitor planning a party to electronically send invitations to others.

A further object of the present invention is to provide a method, apparatus, and system for a party planning web site that facilitates RSVP's from invited guests.

A still further object of the present invention is to provide a method, apparatus, and system for a party planning web site that is capable of being secure.

These and other objects, features and advantages of the present invention will become more apparent with reference to the accompanying specification.

### BRIEF SUMMARY OF THE INVENTION

The invention is a party planning web site with related services. One aspect of the invention allows a party planner to visit the web site and create a party. The party is created by entering the names and/or e-mail addresses of guests who are invited to the party. The invention electronically sends invitations and manages the guest list. In a preferred form, the invention sends an e-mail to the invitee with a link to the invitation located on the party planning web site. The guest can then follow the link to the party planning web site and is then prompted for RSVP information. The invention tracks and stores the RSVP information for the party planner. The party planner can then visit the web site to see who is coming to the party, who is not, who has not yet responded, and related information.

Another aspect of the invention relates to content. This includes not only general party related content but also specific content that a visitor purposely associates with the party. The party planner is permitted to associate content such as culinary recipes, items to buy or rent for the party, decorating ideas and decorations, and other content to the party. The associated information may be a link to the content and the content may be located on the party planning web site. The content may also be located on a third party web site. By permitting the party planner to make these associations, numerous advantages are realized. These include the convenience provided to the party planner as all party related information is stored in one conveniently accessible place. In addition, the party planner can make purchases of the items to buy, arrange for the rental of items, or otherwise benefit from the other content associated with the party. This also provides an advantage to the web site in that the party planner uses the web site more often and for longer periods of time. In addition, the party planner is more likely to make purchases or rentals from the web site or a third party web site associated with the web site.

### BRIEF DESCRIPTION OF THE DRAWINGS

FIG. 1 is a diagram showing a portion of the information flow of the present invention between a party planning site and a visitor.

FIG. 2 is an illustration of a party planning web page.

FIG. 3 is an illustration of a log-in web page associated with a party planning web site.

FIG. 4 is an illustration of a web page associated with a party planning web site for planning a new party.

FIG. 5 is an illustration of a web page for planning a party that allows content associated with parties to be associated with the party.

FIG. 6 is a web page of a party planning web site that allows a party planner to associate content from another web page with a party.

FIG. 7 is a web page for a party planning web site that allows a party planner to associate a culinary recipe with a party.

FIG. 8 is a web page of a party planning web site that allows a party planner to create a guest list to associate with a party.

FIG. 9 is a web page associated with a party planning web site that provides a guest with an invitation and capability to RSVP.

FIG. 10 is a web page associated with a party planning web site that allows a party planner to monitor a guest list and RSVP's for the invited guests.

### DETAILED DESCRIPTION OF THE INVENTION

The present invention relates to a planning party web site that provides a visitor (party planner) with the ability to plan a party. The party is planned in a manner that encourages the party planner to send invitations to others. The invitations refer the invited guests to the web site. In addition, the web site facilitates the party planner's ability to provide associations with content related to the web site.

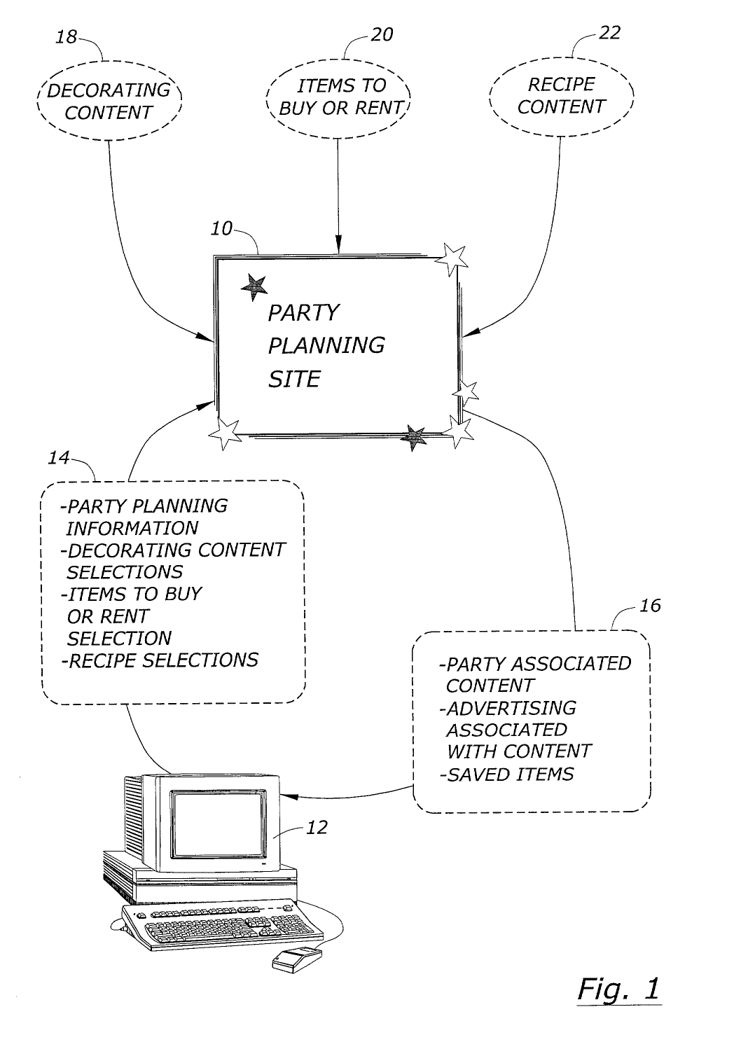

The information flow of the web site is best shown in FIG. 1. The party planning web site 10 may be implemented on any number of servers running any number of operating systems, web site server software and related software. A party planner 12 may use a computer or other web-enabled device to access the party planning web site 10. The invention is not limited to the specific technology used to deploy the invention.

Planning a party includes sending information 14 to the party planning web site 10. This information includes general party planning information as is generally associated with a party as well as other information. This other information can include decorating content selections, items to buy, items to rent for the party, and recipe selections for food and drink to be served at the party. The party planning site 10 also sends party related information to the party planner 12. This information can include party associated content, advertising associated with the content, as well as saved items such as saved party information.

The party planning site also provides the ability for users to selectively associate various party related content with a particular party. This party related content includes decorating content 18, items to buy or rent 20, and recipe content 22.

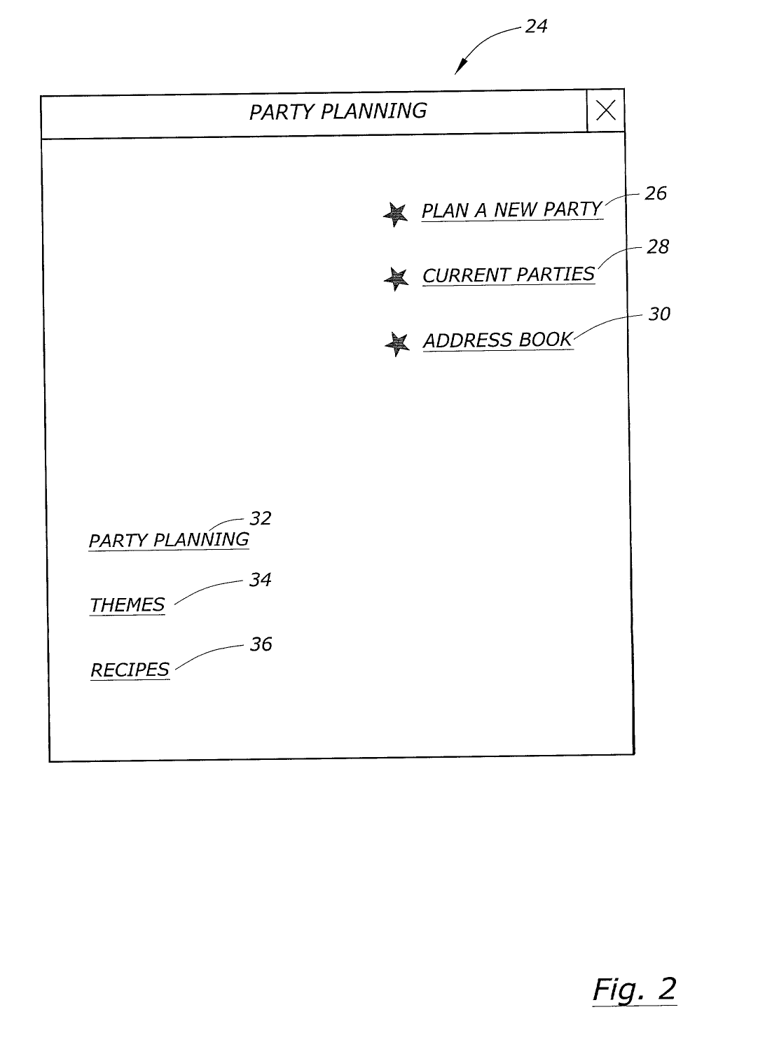

An initial party planning web page 24 is shown in FIG. 2. The party planning web page 24 provides a party planner with a number of party planning options. For example, the party planner can follow a new party link 26 to begin planning a new party. The party planner can follow a current party link 28 to view information concerning currently planned parties. The party planner may select the address book link 30 to see a list of potential guests for a party. The party planner may link to general information associated with party planning by following a party planning link 32. The party planner may view information concerning ideas for party themes by following themes link 34. The party planner may view culinary recipes potentially appropriate to prepare for the party by following a recipes link 36. In this respect, the present invention provides content associated with party planning.

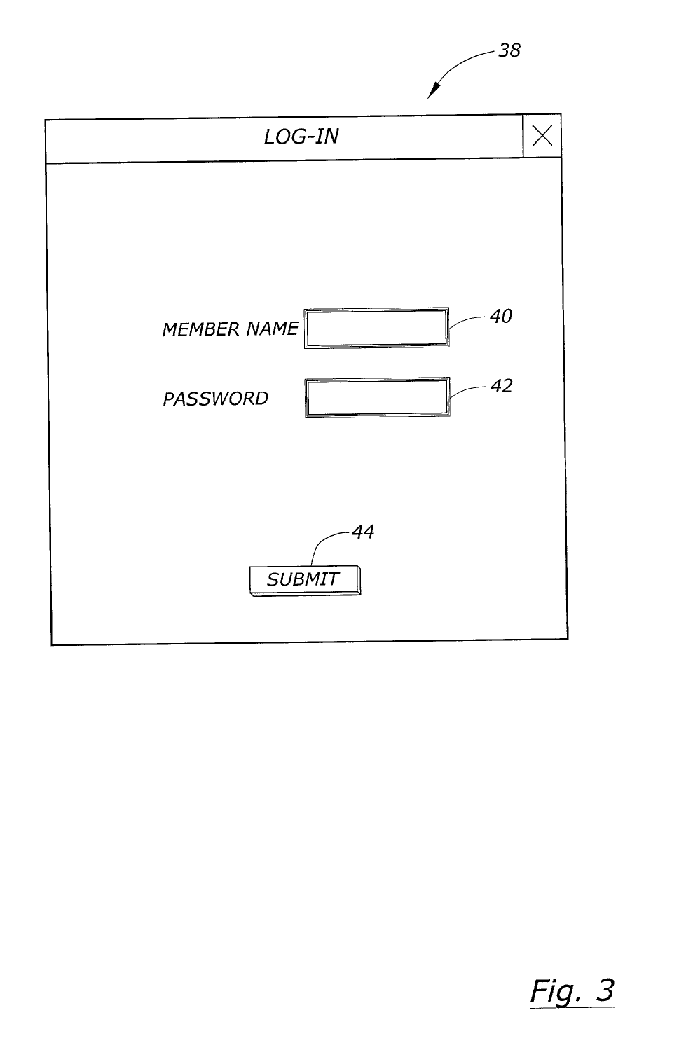

The-present invention contemplates that in order to plan a new party or view information concerning current parties, the party planner must log into the web site. FIG. 3 shows an example log-in web page 38. The log-in web page 38 prompts a party planner to enter a member name 40, a password 42 and to then select a submit button 44 in order to log-in to the web site. The present invention contemplates that portions of the web site may be protected with various types of security. The web site of the present invention is preferably secure. Security can be added through a number of different methods as are known in the art. For example, security can be added through implementation of the secure sockets layer (SSL) protocol or other protocols that implement public/private keys, digital certificates, and other security measures aimed at providing authentication. Similarly, other security protocols or measures that are otherwise known in the art may be used. The present invention is not in any way limited to whether security is used or the type of security used. The present invention merely appreciates that party planning information may be considered confidential and private by a party planner for various reasons.

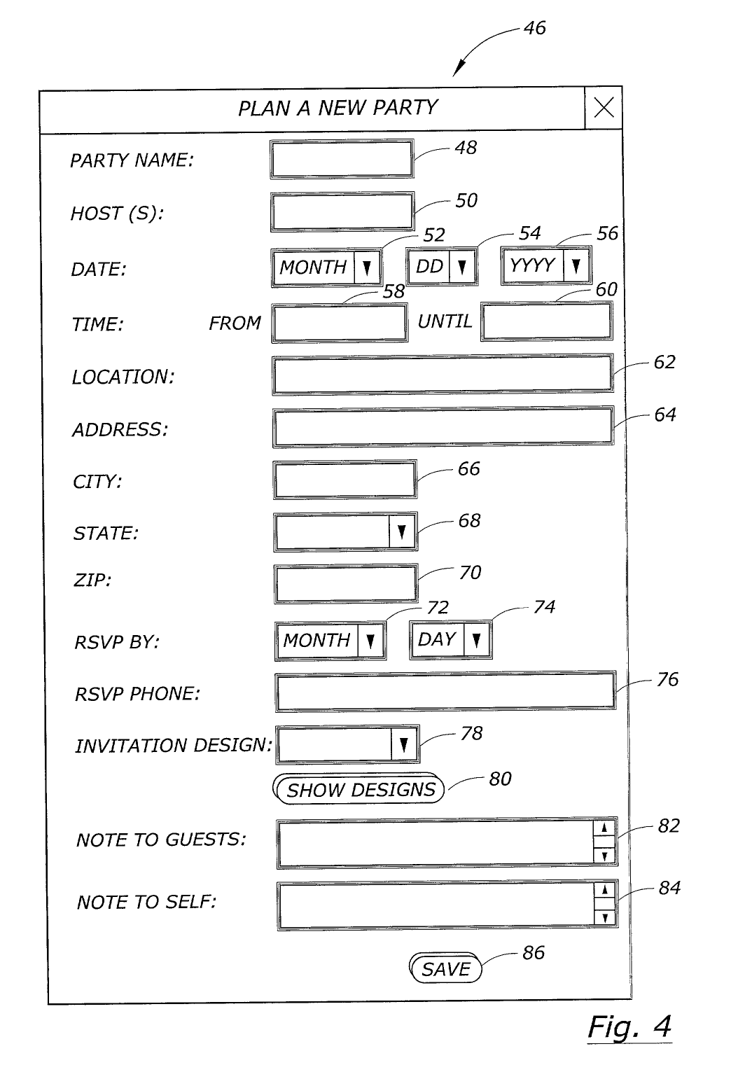

FIG. 4 illustrates a plan a new party web page 46. Here, the party planner provides general information related to the party. This information may include a party name 48. The party name may be associated with an occasion, a person, a theme, an event, or any other party name a visiting party planner desires to use. In addition, the party planner is prompted to enter the name or names of hosts of the party in input box 50. The date of the party is entered through selecting a month from a drop down list box 52, selecting a day from a drop down list box 54, and selecting a year from a drop down list box 56. The party start time is entered in input box 58 and the ending time is entered in input box 60. The location of the party is entered in input box 62 and the address of the party is entered in input box 64, the city in input box 66, the state in drop down list box 68, and the zip in input box 70. An RSVP by date is also provided through selection of a month in drop down list box 72 and a day in drop down list box 74. An RSVP telephone number may be entered in input box 76. The party planner may also select an invitation design through selecting a design from list box 78. The party planner may see various designs by selecting the show designs button 80. The present invention contemplates that any number of designs may be associated with an invitation. The designs may include images related to a theme, occasion, event or otherwise selected. The party planner may also specify a note to guest in the input box 82 as well as notes to self in the appropriate input box 84. Once the party planner has entered the information accordingly in the plan a new party web page 46, the party planner may select the save button 86 to save the information. The present invention contemplates that the information may be saved in various formats. For example, the information may be saved to a database associated with the web server hosting the web site. The invention is in no way limited to a particular type of database used or the method used to save the data. Information concerning the party may also be saved on the computer used by the party planner in the form of a cookie. The present invention contemplates numerous manners to save the party information such as may be known in the art.

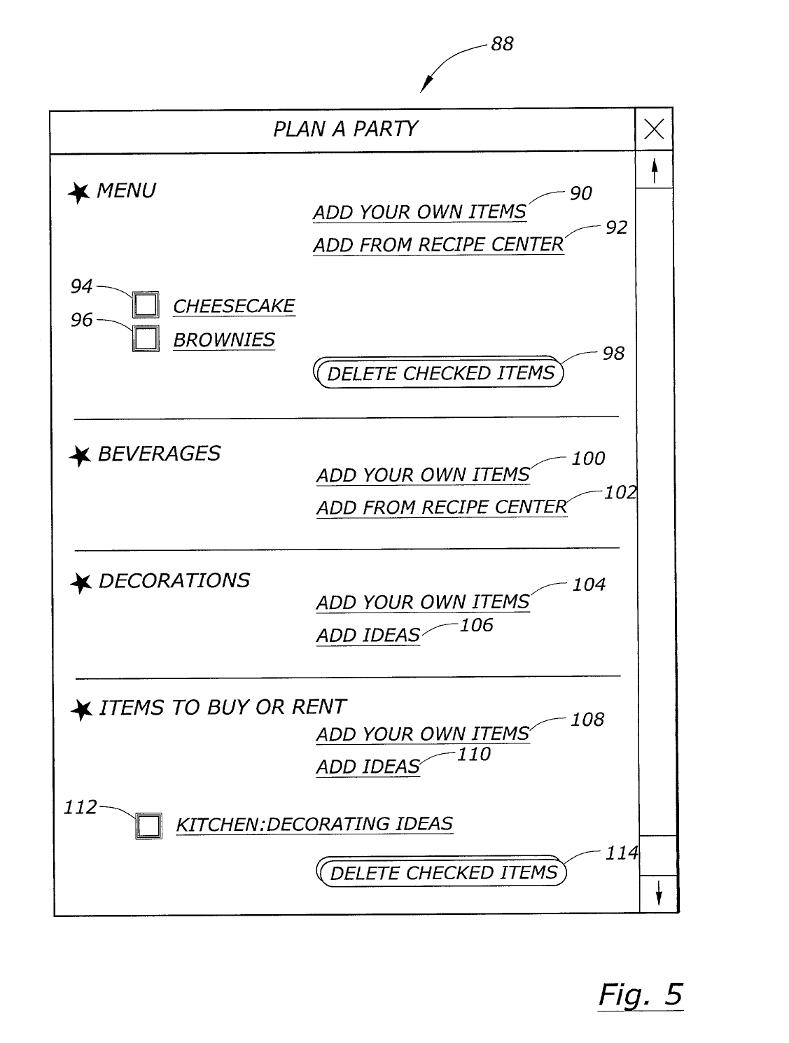

FIG. 5 illustrates a “plan a party” web page 88. The “plan a party” web page 88 includes information that may be associated with a party. This information includes the menu for the party. A party planner may add their own menu items by selecting the “add your own items” link 90. Alternatively, the party planner may selectively associate recipes from a recipe center with the menu of the party. This is performed through selecting the “add from recipe center” link 92. The added menu items are shown with check boxes 94 and 96. The party planner may select either or both of these menu items and delete them. Each of these menu items is a link to an associated recipe. Thus the party planner conveniently has links to recipes for food items on a menu associated with a party. The present invention allows any number of menu items to be associated with the party including links to the associated recipes.

The party planner may also select beverages to associate with the party through selecting the “add your own items” beverage link 100 or the “add beverages from recipe center” link 102. Similarly, the party planner may select decorations to associate with the party by selecting the “add your own items” link 104 or the “add decorating ideas” link 106.

The “plan a party” web site 88 also permits a party planner to associate items to buy or rent with the party. The party planner can select the “add your own items” link 108 to begin the process of adding items to buy or rent to the party. The party planner may also select the “add ideas” link 110 to select other web pages to associate with the party. As shown in FIG. 5, the party planner has added kitchen decorating ideas. The check box 112 is associated with one link previously selected by a party planner. The party planner may select this check box 112 and then delete the links by selecting the “delete checked items” button 114. In this manner, the “plan a party” web page 88 of FIG. 5 shows associations to content that have been made by the party planner.

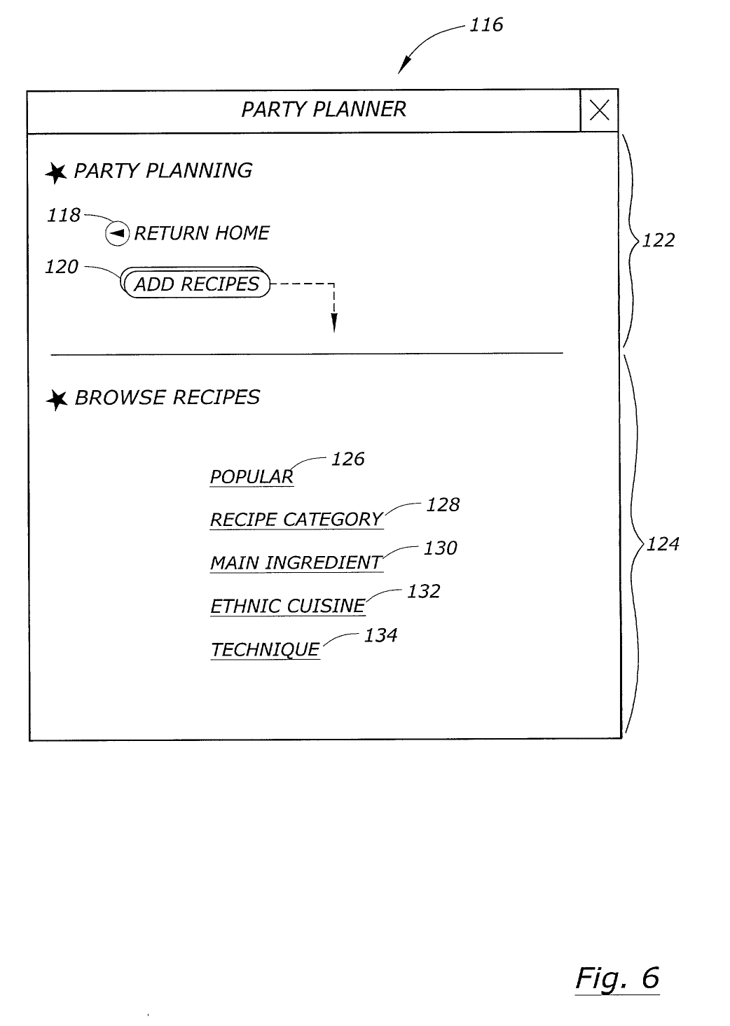

The manner in which these associations are made is further shown in FIG. 6. In FIG. 6, a party planner web page 116 is illustrated. At the top of this web page 116 is a first frame 122. The first frame 122 is associated with the party planning web site. This frame includes a “return home” link 118 which the party planner can select to return to the party planning web site. The frame 122 also includes an “add recipe” button 120 that the party planner selects when the party planner wants to associate the content within the second frame 124 with the party. In frame 124, a “browse recipes” web page is shown. This web page may be a web page of content associated with the web site or may be from a web page on a third party web site. Links to various types of recipes are shown, such as a “popular” link 126, a “recipe category” link 128, “main ingredient” link 130, an “ethnic cuisine” link 132, and a “culinary technique” link 134. The invention permits a party planner to navigate to a desired web page and then to associate that information with the party.

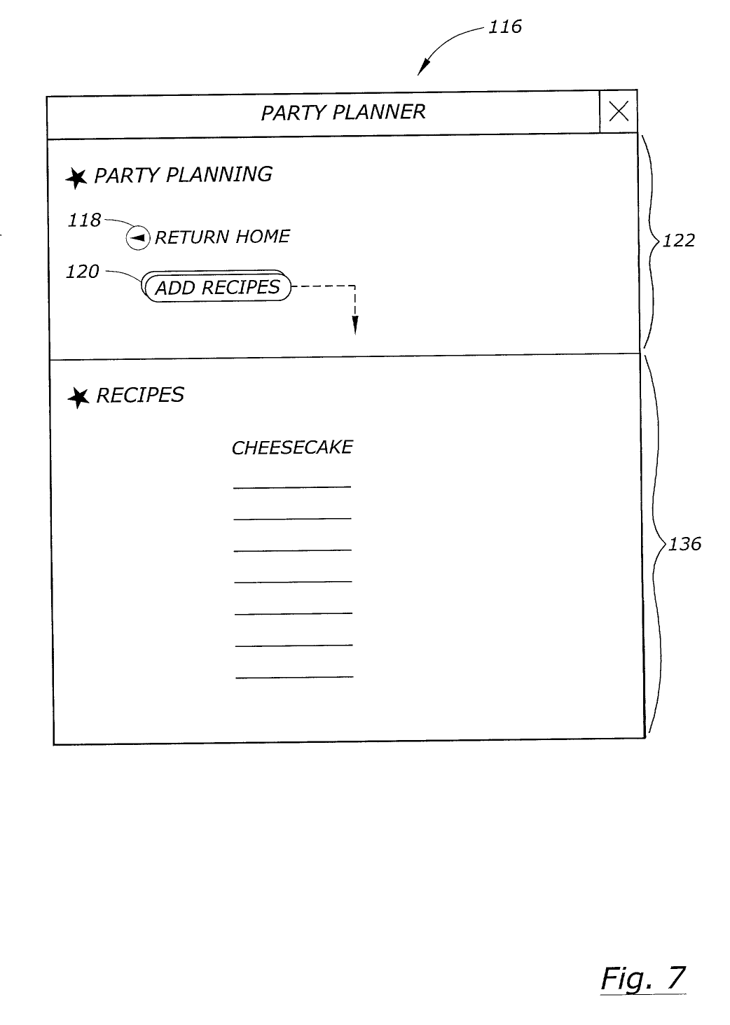

FIG. 7 illustrates another example of the party planner web page 116 with the same first frame 122 but a different second frame 136. Within the second frame 136 is a web page showing a particular recipe, in this instance a recipe for cheesecake. Once the party planner has selected a particular recipe that is shown in frame 136, the party planner may then select the “add recipe” button 120 to associate the recipe shown in frame 136 with the party that is being planned.

In this manner, a party planner may make any number of associations relating content with the party. This provides a valuable service to the party planner as there are a number of different types of items that can be associated with the party planning. This also provides the party planner with a great deal of flexibility in planning the party because the party planner actually selects the association to be made. Preferably a great number of selections are available that may be of interest to the party planner. Preferably the content selections are also commonly owned by the web site, but these options are not required. This added flexibility provides the party planner additional incentive to use the party planning web site and increases the amount of time that the party planner spends using the party planning web site to plan a party. At the same time, this ability to make associations makes the services more useful and valuable.

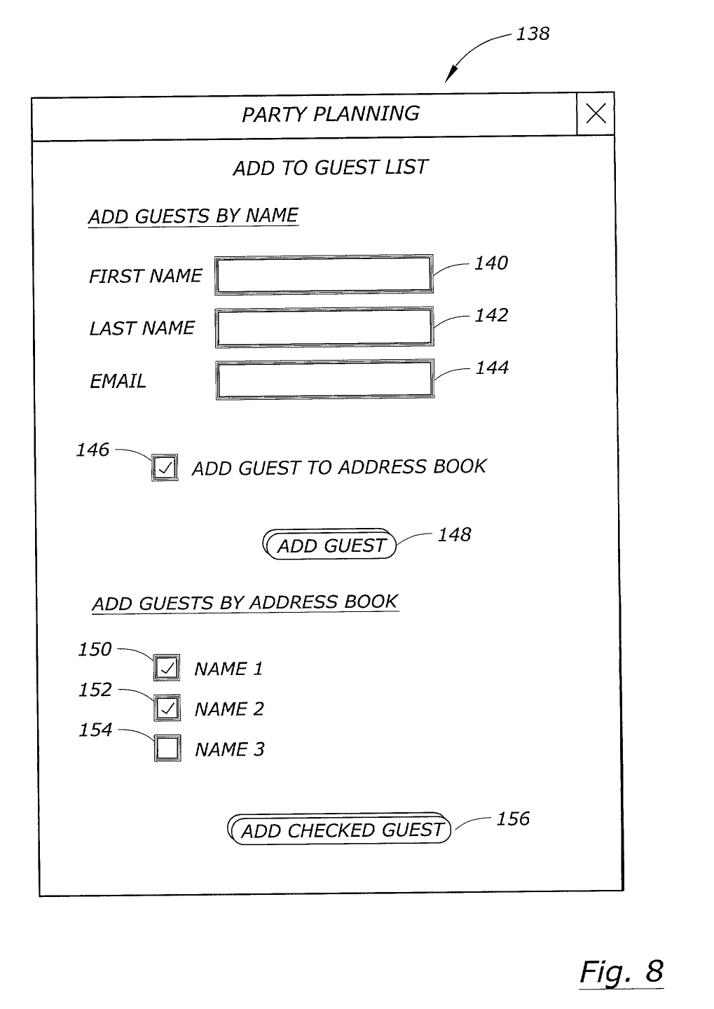

FIGS. 8 through 10 show the guest list aspect of the present invention. In FIG. 8, a “party planning” web page 138 is shown. Guests that are to be invited may be added by entering a first name in the input box 140, a last name in the input box 142, and an e-mail address in the input box 144. Optionally, the option box 146 may be selected so that the guest entered may be added to an address book. The party planner may then select the “add guest” button 148 to add the guests to the party list. In addition, guests that are already in the address book, such as guests invited to previous parties thrown by the party planner, may be entered by selecting the option box associated with their name, such as shown by reference numerals 150, 152, and 154. These guests previously entered in the address book may then be selected and added to the quest list by selecting the “add checked guest” button 156.

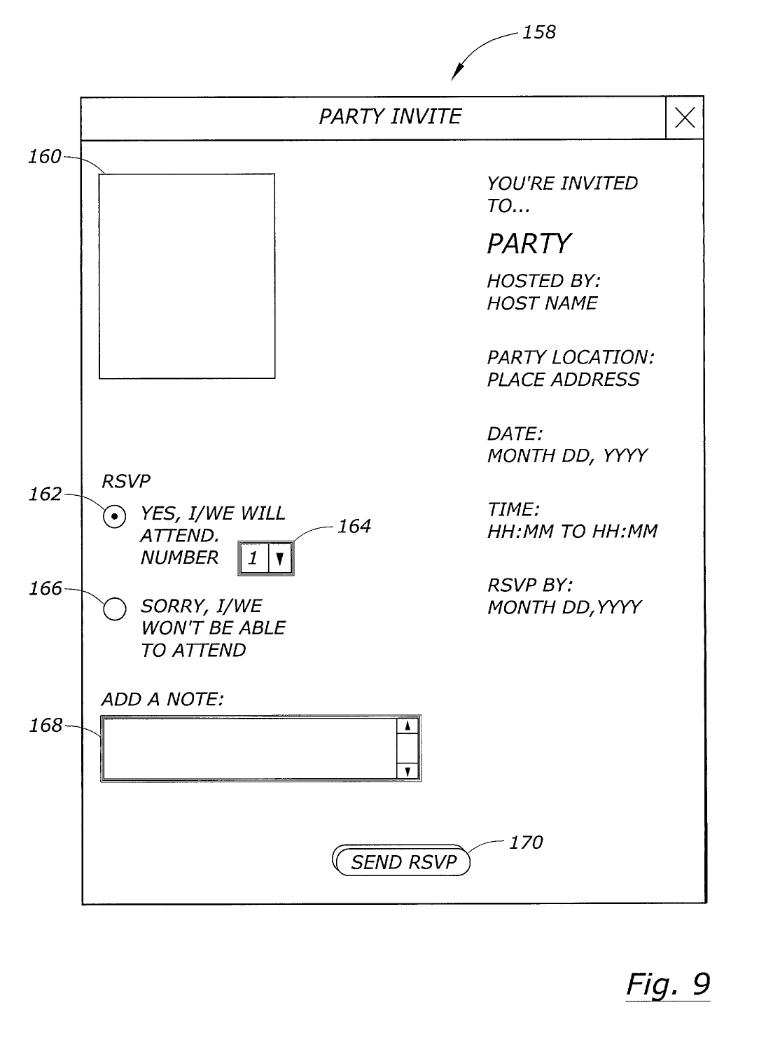

Once the guests to be invited have been selected, the present invention permits the guests to be e-mailed invitations. In the e-mail received by each guest, there is a link back to the web site. Once this link is followed, the guest receives the web page that may be similar to the “party invite” web page 158 of FIG. 9. The invitation may include a graphic 160 that is appropriate for the party's theme or occasion or is otherwise selected by the party planner. The “party invite” web page 158 permits the guests to RSVP by indicating that they will attend by selecting the option button 162 and indicating the number that will be attending from the drop down list box 164. Similarly, the invited guests can select the option button 166 to indicate that the guests will not be able to attend. The guests may also enter a note in the text area 168 to provide a personalized note to the party planner. Once the guest has completed this information, the guest may select the “send RSVP” button 170 to send this RSVP information to the web site. In this manner, the party planner has referred the guests to the party planning web site. This increases the traffic to the party planning web site and can be leveraged in a number of ways. The “party invite” web page 158 may include advertising and/or marketing information to be viewed by the guest. In addition, the guest is made aware of the party planning web site and may desire to use the same web site for planning the guest's parties. This also may increase the goodwill associated with the party planning web site.

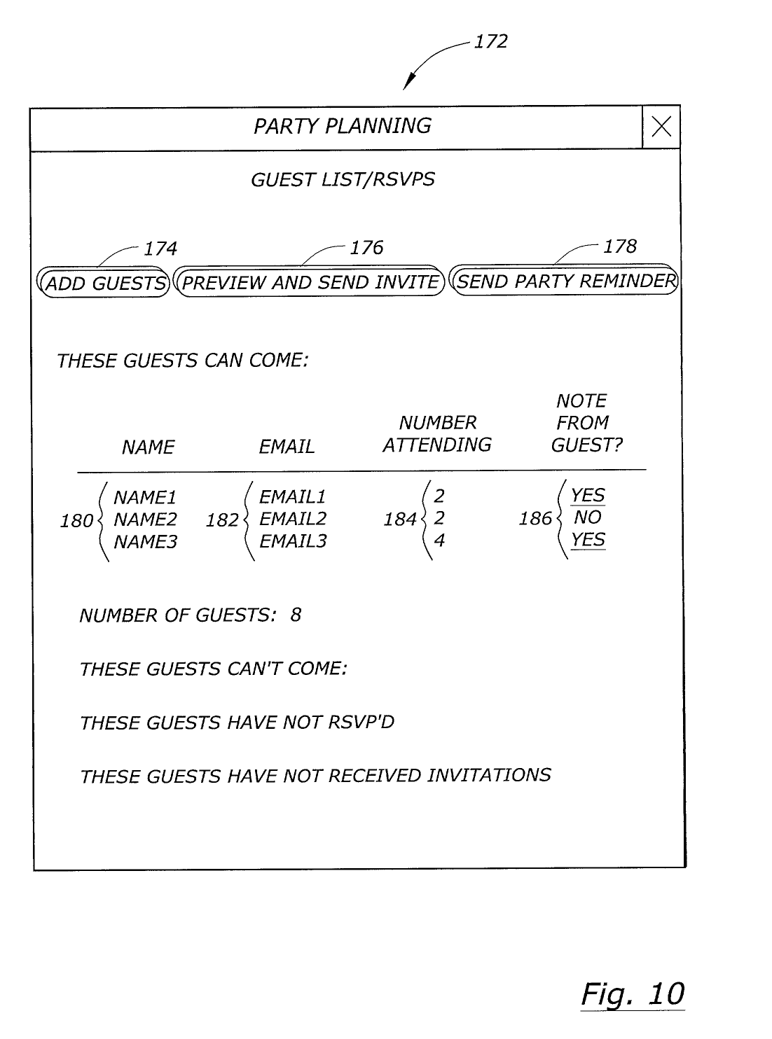

The use of the guest list also encourages the party planner to return to the party planning web site to receive an update as to the guest list and the RSVP's sent by guests. In FIG. 10, a “party planning” web page 172 is shown that displays the current guest list and RSVP's. The party planner may add guests by selecting the “add guest” button 174. The party planner may also send additional invitations by selecting the “preview and send invite” button 176. The party planner may also send party reminders to guests who have not yet RSVP'd by selecting the “send party reminder” button 178. The “party planning” web page 172 also includes a list of the guests who can come including their name in a name column 180, their e-mail address in the address column 182, the number attending in the number column 184 and whether there is a note from the guest in the note column 186. When there is a note from the guest, there will be a hyperlink to the note so that the party planner can view the note. A total number of guests that have indicated they are coming is also displayed. If there are guests that cannot come, this information can also be displayed. A listing of guests who have not RSVP'd may also be shown. If some guests have been added but they have not been sent invitations yet, this information may also be shown. In this manner, the party planner has incentive to return to the web site to add to the guest list, check the guest list, and otherwise manage the guest list.

The present invention contemplates that when associations to content are made by the party planner, the web site may provide the party planner with the opportunity to make online purchases of goods or services either at the “party planning” web site or on a web site linked or otherwise associated with the “party planning” web site. This provides the party planner with added convenience. In addition, this provides the “party planning” web site with an opportunity to tie e-commerce or sales to the “party planning” web site.

The present invention increases the traffic to the web site by providing a valuable service to those who wish to plan parties. The ability to associate links to content with the party provides party planners with the advantage of easily accessing party related information from a single web site. In addition, the method of adding the party association links and the method of sending invitations and receiving RSVP's increases the amount of time spent on the web site by the party planner. The receiving of RSVP's from the invited guests also increases the traffic to the web site. Thus, a method and system for party planning has been described that provides advantages to a party planning web site and to party planners who use the web site. The present invention contemplates numerous variations in the format and display of information, the specific types of associations made, and other variations such as may be known in the art.

What is claimed is:

1. A new method of providing recurring traffic to a web site through hosting party planning services, comprising: promoting a web site as a party planning web site; providing content on the web site related to party planning; prompting a visitor to the web site for party information; facilitating a user's ability to selectively associate party
related content links with the party information; and saving the party information including the party related content links.

2. The method of claim 1 further comprising restoring the saved party information when the visitor leaves and then returns to the web site.

3. The method of claim 1 wherein the step of selectively associating party related content links with the party information includes selectively associating links to culinary recipes with the party information.

4. The method of claim 1 wherein the step of selectively associating party related content links with the party information includes selectively associating links to decorating content with the party information.

5. The method of claim 1 wherein the step of selectively associating party related content links with the party information includes selectively associating links to items to buy or rent with the party information.

6. The method of claim 1 wherein the party information includes a list of e-mail addresses associated with guests to invite to the party.

7. The method of claim 6 further comprising:
electronically notifying a guest of a party invitation;
electronically facilitating RSVP of the guest; and
maintaining a guest list including RSVP information accessible to the visitor of the web site.

8. An online system for planning a party comprising:
means for designing e-mail invitations;
means for sending e-mail invitations;
means for tracking RSVP'S;
means for creating party menus; and
means for building guest lists.

9. The online system of claim 8 further comprising means for associating decorating ideas with the party.

10. The online system of claim 8 further comprising means for associating items to buy with the party.

11. The online system of claim 8 further comprising means for printing a party invitation.

12. The online system of claim 8 further comprising means for associating items to rent with the party.

13. A web site for party planning services comprising:
a guest list management feature, the guest list management feature allowing a party planner to invite guests via electronic mail, to receive RSVP information from invited guests and to monitor the status of RSVP's; and
a party association feature providing a party planner the ability to associate online content with a party.

14. The web site of claim 13 wherein the party association feature comprises a party menu feature, the party menu feature allowing a party planner to associate online culinary recipes with a party.

15. The web site of claim 13 wherein the party association feature comprises in items to buy association feature, the items to buy association feature allowing a party planner to associate items to buy for a party.

16. The web site of claim 15 further comprising an e-commerce component, the ecommerce component facilitating the online purchase of items that a party planner has associated with a party.

17. A web site for party planning comprising:
a data storage component for storing party planning information;
an association component having a content frame for displaying party-related content from a web page and a navigation frame, the navigation frame including a control responsive to a user event wherein upon the user event a link to the web page of the content frame is stored in the data storage component; and
a guest list management component having at least one input for receiving a guest-to-invite e-mail address.

18. The web site of claim 17 further comprising a party-related content component having one or more web pages displaying party-related content displayable in the content frame of the association component.

19. The web site of claim 18 wherein the party-related content component includes a plurality of culinary recipes.
